(19) United States
(12) Patent Application Publication
(10) Pub. No.: US 2018/0229850 A1
(43) Pub. Date: Aug. 16, 2018

(54) ANTI-ICING SYSTEM FOR GAS TURBINE ENGINE

(71) Applicant: PRATT & WHITNEY CANADA CORP., Longueuil (CA)

(72) Inventors: David MENHEERE, Norval (CA); Daniel ALECU, Brampton (CA)

(21) Appl. No.: 15/433,645

(22) Filed: Feb. 15, 2017

(51) Int. Cl. B64D 15/02; F02C 7/047; B64D 33/02

(52) U.S. Cl. CPC B64D 15/02; F02C 7/047; B64D 33/02; B64D 2033/0233; F05D 2260/213; F05D 2260/232; F05D 2220/323

(57) ABSTRACT

An anti-icing system for a gas turbine engine comprises a closed circuit containing a change-phase fluid, at least one heating component for boiling the change-phase fluid, the anti-icing system configured so that the change-phase fluid partially vaporizes to a vapour state when boiled by the at least one heating component. The closed circuit has an anti-icing cavity adapted to be in heat exchange with an anti-icing surface of the gas turbine engine for the change-phase fluid to release heat to the anti-icing surface and condense. A feed conduit(s) has an outlet end in fluid communication with the anti-icing cavity to feed the change-phase fluid in vapour state from heating by the at least one heating component to the anti-icing cavity, and at least one return conduit having an outlet end in fluid communication with the anti-icing cavity to direct condensed change-phase fluid from the anti-icing cavity to the at least one heating component. A method for heating an anti-icing surface of an aircraft is also provided.

### TECHNICAL FIELD

The application relates generally to gas turbine engines and, more particularly, to an anti-icing system of a gas turbine engine.

### BACKGROUND OF THE ART

In aircraft, traditional de-icing and/or anti-icing methods and systems require high temperature bleed air from the engine to be ducted to the inlet or areas requiring anti-icing. The bleed air in high pressure ratio engines is at a high temperature and materials have to carefully chosen to sustain such high pressures. The bleed air may also increase the fuel consumption of the engine because of the work invested in producing the high pressure air. The high temperature air is routed through a distribution tube in the inlet to ensure that the defrost zones are heated evenly and all areas are free of frost or ice build-up. This air must have a path to exit the inlet to maintain flow and energy, whereby the air may be exhausted overboard. The exhaust duct may add drag to the nacelle. Such anti-icing system may also require an inspection port which adds another feature that interrupts the nacelle surface which is undesirable.

### SUMMARY

In one aspect, there is provided an anti-icing system for a gas turbine engine comprising: a closed circuit containing a change-phase fluid, at least one heating component for boiling the change-phase fluid, the anti-icing system configured so that the change-phase fluid partially vaporizes to a vapour state when boiled by the at least one heating component, the closed circuit having an anti-icing cavity adapted to be in heat exchange with an anti-icing surface of the gas turbine engine for the change-phase fluid to release heat to the anti-icing surface and condense, at least one feed conduit having an outlet end in fluid communication with the anti-icing cavity to feed the change-phase fluid in vapour state from heating by the at least one heating component to the anti-icing cavity, and at least one return conduit having an outlet end in fluid communication with the anti-icing cavity to direct condensed change-phase fluid from the anti-icing cavity to the at least one heating component.

In another aspect, there is provided a method for heating an anti-icing surface of an aircraft comprising: heating a change-phase fluid in a closed circuit to boil the change-phase fluid into a vapour state, directing the change-phase fluid in the vapour state to an anti-icing cavity located in heat exchange relation with the anti-icing surface of the gas turbine to condense the change-phase fluid in the vapour state by heating the anti-icing surface, and collecting the condensed change-phase fluid in a lower portion of the anti-icing cavity and directing the condensed change-phase fluid in the closed circuit to the at least one heating component to boil the change-phase fluid.

### DESCRIPTION OF THE DRAWINGS

Reference is now made to the accompanying figures in which:

FIG. 1 is a schematic cross-sectional view of a gas turbine engine;

FIG. 2 is a block diagram of an anti-icing system for a gas turbine engine in accordance with the present disclosure;

FIG. 3 is a schematic partly sectioned view of an engine inlet featuring an anti-icing cavity of the anti-icing system for an embodiment of the anti-icing system of FIG. 2; and

FIG. 4 is schematic view the anti-icing system of FIG. 3, extending to a reservoir thereof.

### DETAILED DESCRIPTION

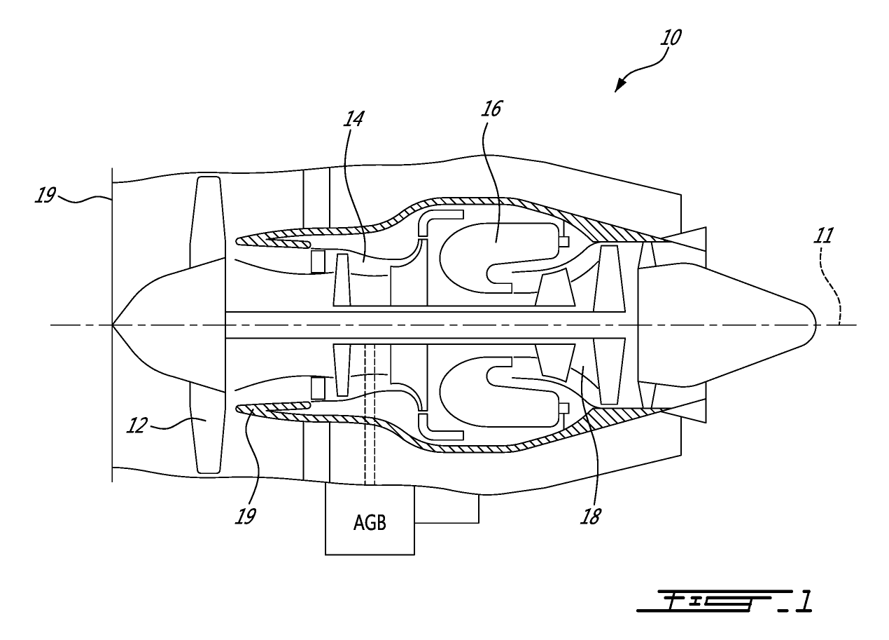

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. The gas turbine engine 10 may also have leading surfaces such as shown by 19, upon which frost or ice may have a tendency to form, and hence also referred to as anti-icing surface, defrost surface, exposed surface in that it is exposed to ambient air, exterior surface. As is known, the gas turbine engine 10 may have different engine systems, such as an auxiliary gear box AGB, and integrated drive generator that generate heat and hence may require cooling. Likewise, the gas turbine engine 10 may have an air cooled oil cooler used for cooling various engine systems, but the air cooled oil cooler must reject absorbed heat.

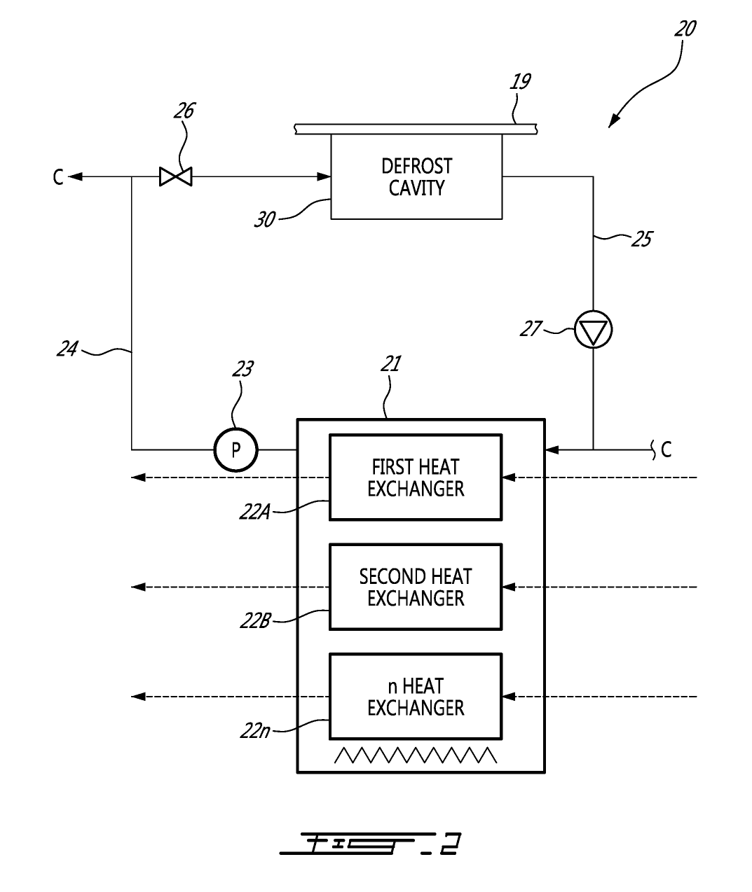

Referring to FIG. 2, an anti-icing system in accordance with the present disclosure is generally shown at 20. The expression “anti-icing” in anti-icing system may refer to the capacity of the system 20 to melt anti-icing or ice formations (a.k.a., ice build-ups), and/or the capacity of the system 20 to prevent frost or ice formation, or cause a defrost. The anti-icing system 20 is a closed circuit type of system, in that the fluid(s) it contains is(are) captive therein, with the exception of undesired leaks. Hence, the anti-icing system 20 is closed in that it allows heat exchanges as desired, but generally prevents a transfer of mass or loss of mass of the fluid(s) it contains. The anti-icing system 20 includes a cooling fluid, selected to be a change-phase fluid, i.e., selected for the fluid to change phase during operation of the anti-icing system 20. The cooling fluid may also be known as a coolant, as a refrigerant, etc. However, for simplicity and clarity, the expression “change-phase fluid” will be used, so as not to mix it up with the coolants used in closed circuits associated with engine systems, with which the change-phase fluid will be in a heat-exchange relation. The cooling fluid is said to be a change-phase fluid in that it changes phases between liquid and vapour in a vapour-condensation cycle, in such a way that it may store latent heat and efficiently absorb heat while remaining at a same temperature during phase change. Moreover, the change-phase fluid is known to have a greater density when in a liquid phase than in a vapour phase, which results in condensate to drip by gravity while vapour rises. The change-phase fluid may therefore circulate by thermosiphon (a.k.a., thermosyphon) effect between parts of the anti-icing system 20. According to an embodiment, the change-phase fluid is water or water-based, and may include other constituents, such as glycol, salts, etc. Alternatively, other change-phase fluids, without water, may be used. In an embodiment, the change-phase fluid is non flammable. Hence, the change-phase fluid is in a vapour state and in a liquid state depending on the location in the anti-icing system 20, and the anti-icing system 20 may also include other fluids such as air.

The anti-icing system 20 may have one or more reservoirs 21. The reservoir 21 may be known as a receiver, a tank, etc. The reservoir 21 receives and stores the change-phase fluid, with the liquid state of the fluid in a bottom of the reservoir 21. According to an embodiment, one or more heat exchangers, illustrated as 22A, 22B and 22n (jointly referred to as 22) are also located in the reservoir 21, for coolants circulating in the heat exchangers 22 to be in a heat exchange relation with the fluid in the reservoir 21, i.e., in a non-mass transfer relation. Although shown schematically in FIG. 2, the heat exchangers 22 may have any appropriate configuration or surface component to enhance heat exchange, such as coils, fins, etc. Moreover, although the heat exchangers 22 are depicted as sharing a same reservoir 21, all or some of the heat exchangers 22 may have their own dedicated reservoir 21, in an embodiment featuring numerous heat exchangers 22. It is also contemplated to provide as part of the exchangers 22 an electric heating coil that is powered to boil the change-phase fluid.

According to an embodiment, each heat exchanger 22 is associated with an own engine system. Stated different, each heat exchanger 22 is tasked with releasing heat from its related engine system. Hence, the heat exchangers 22 are also part of closed circuits, extending from the reservoir 21 to the engine system. The engine systems may include auxiliary gear box ABG (FIG. 1), and integrated drive generator. Also, one of the heat exchangers 22 may be part of an air cooled oil cooler. According to an embodiment, the heat exchangers 22 may be stacked one atop the other in the reservoir 21, with the heat exchangers 22 all bathing in the liquid state of the change-phase fluid. Coolants circulating in any one of the heat exchangers 22 may release heat to the change-phase fluid in the reservoir 21. Consequently, the change-phase fluid may boil, with vapour resulting from the heat absorption.

A pressure regulator 23 may be provided in one of the feed conduits 24, such as to regulate a pressure in the reservoir 21, and therefore control a boiling temperature of the change-phase fluid. The pressure regulator 23 may be any appropriate device that operates to maintain a given regulated pressure in the reservoir 21, such that vapour exiting via the feed conduits 24 is above the regulated pressure. According to an embodiment, the pressure regulator 23 is a sourceless device, in that it is not powered by an external power source, and that is set based on the planned operation parameters of the gas turbine engine 10. For example, the pressure regulator 23 may be spring operated. Alternatively, the pressure regulator 23 may be a powered device, such as a solenoid valve, for instance with associated sensors or pressure detectors. Although not shown, complementary devices, such as a check valve, may be located in return conduits 25 directing condensate to the reservoir 21. FIG. 2 shows a schematic configuration of the anti-icing system 20 with a single feed conduit 24 and single return conduit 25, but 24 and 25 may include networks of conduits in any appropriate arrangements, for instance as shown in embodiments described hereinafter. The feed conduits 24 may feature a valve 26 selectively operable if anti-icing heat is required. The feed conduit 24 may otherwise divert part or all of the change-phase fluid in the vapour state toward a cooling phase C to release heat from the change-phase fluid if necessary. In the illustrated embodiment, the cooling phase C is in parallel to an anti-icing stage defined by the anti-icing cavity 30.

The change-phase fluid in vapour state is directed by the conduit(s) 24 to the anti-icing cavity 30 in which change-phase fluid in vapour state will condense on the wall in heat exchange with the leading surface 19. The anti-icing cavity 30 may be at any location in the gas turbine engine 10 in which anti-icing and/or de-icing is required. As described hereinafter, according to one embodiment, the anti-icing cavity 30 is conductively related to any of the leading surfaces 19 requiring anti-icing or de-icing. For example, the leading surface 19 may be that of an inlet of the engine case, of the nacelle, of the bypass duct, etc. Moreover, the leading surface 19 may also be part of other aircraft components, including the wings. According to an embodiment, the wall defining a portion of the anti-icing cavity 30 includes the leading surface 19. Hence, such direct conductive relation, in contrast to embodiments of the present disclosure in which a gap is between the anti-icing cavity 30 and the leading surface 19 (e.g., liquid gap, hydrogen gap, helium gap, conductive gel gap, conductive adhesive gap, conductive composite material gap, metallic insert composite gap), may more efficiently anti-icing the leading surface 19. According to an embodiment, the leading surface 19 is part of the aluminum outer skin of the engine inlet, and the anti-icing cavity 30 is delimited aft by the aluminum outer skin.

In heating the leading surface 19, the change-phase fluid may condensate. The leading surface 19 may therefore be heated to the condensation temperature of the change-phase fluid, without substantially exceeding the condensation temperature. The conduits 25 are therefore arranged to direct the condensate to the reservoir 21. According to an embodiment, the anti-icing system 20 relies on vapour density to feed the anti-icing cavity 30 and on gravity for the condensate to reach the reservoir 21, such that no motive force is required to move the cooling fluid, i.e., no powered device may be necessary, the system relying on thermosiphon effect for fluid displacement. However, it is contemplated to provide a pump 27 (such as one or more electric pumps) or like powered device to assist in moving the cooling fluid.

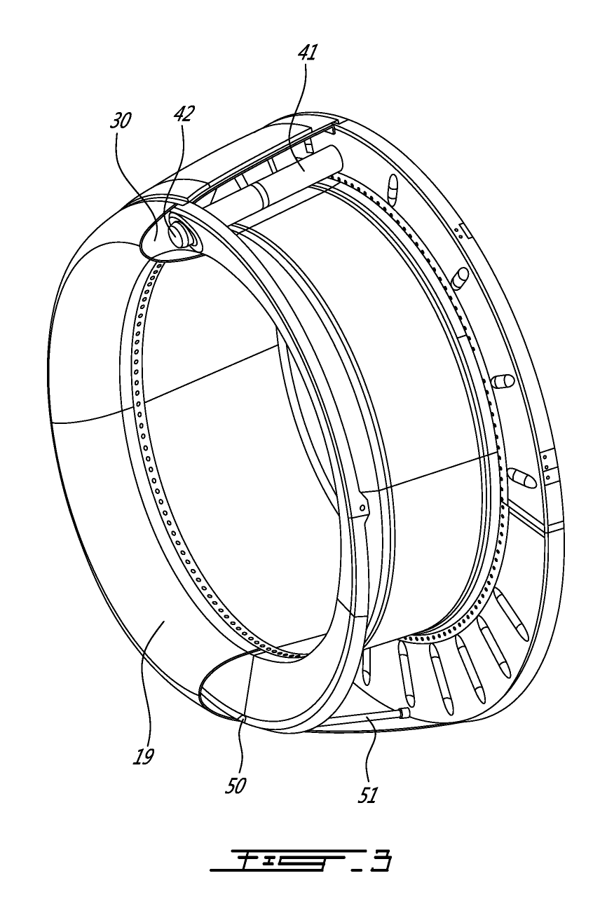

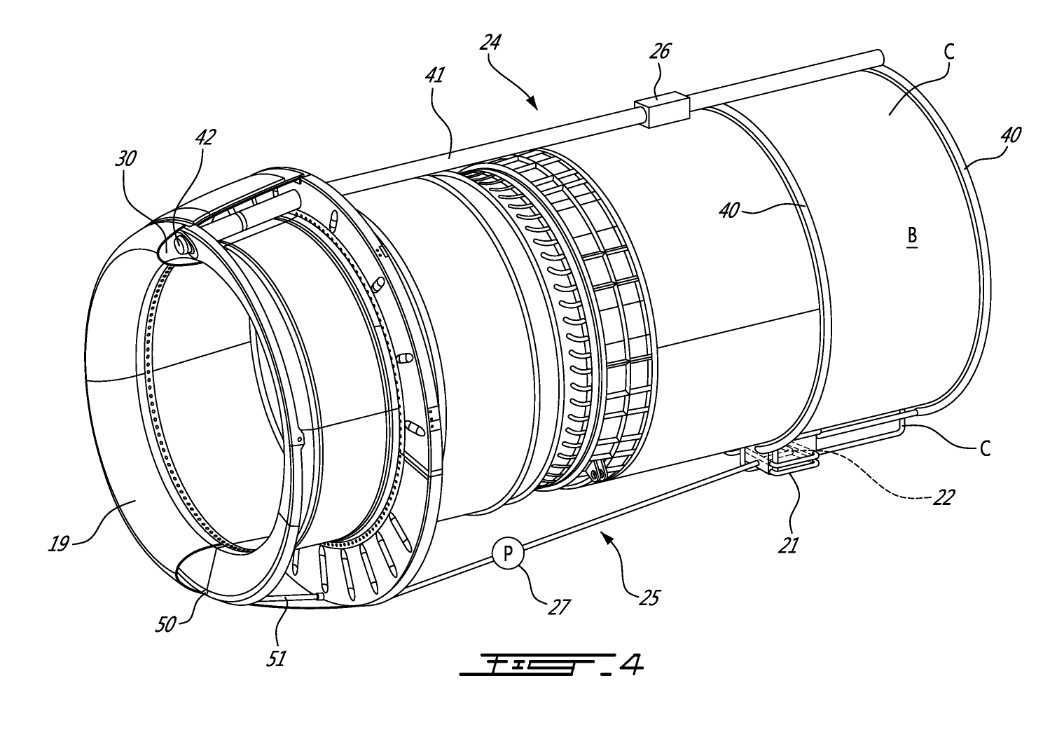

Referring to FIGS. 3 and 4, there is shown an embodiment in which the anti-icing cavity 30 is used to anti-icing and/or device the annular leading surface 19 of the engine inlet. The reservoir 21 is located at a bottom of a bypass duct wall B, but may be at other locations. The feed conduits 24 are located on an upper portion of the reservoir 21 to direct vapour out of the reservoir 21, while the return conduits 25 are connected to a bottom portion of the reservoir 21 to feed condensate to the reservoir 21. By providing vapour and fluid connections at each end and on the sides of the reservoir 21 and stacking the heat exchangers 22 the effect of attitude and roll may be reduced.

According to an embodiment, as shown in FIG. 4, the feed conduits 24 may include arcuate conduit segments 40 extending from straight conduit portions, to surround the bypass duct wall B. As part of the network of conduits 24, the arcuate conduit segments 40 are tasked with directing vapour of the closed circuit toward a top of the bypass duct wall B. Other shapes of conduit segments may be used, but the arcuate conduit segments 40 may appropriately be positioned in close proximity to the bypass duct wall B and hence reduce the length of pipe to be travelled by the change-phase fluid. According to an embodiment, the ends of the arcuate conduit segments 40 are open at a top of the bypass duct wall B, for at least a portion of the change-phase fluid to be optionally sent the cooling phase C around the bypass duct wall B. In such a case, an annular chamber is defined between the radially outer surface of the bypass duct wall B and annular wall sealingly mounted around the radially outer surface, to form a vapour receiving annular cavity. Therefore, vapor fed by the conduits 24 via the conduit segments 40 may fill the annular chamber. As the annular chamber is defined by the bypass duct wall B, the vapour will be in heat exchange relation with the bypass duct wall B. As the bypass duct wall B is continuously cooled by a flow of bypass air, the vapour may condensate. Hence, the condensate will trickle down by gravity, and accumulate at a bottom of the annular chamber, to be directed to the reservoir 21.

The conduit 24 further includes a straight segment 41 that extends from a top of the arcuate conduit segments 40 to the anti-icing cavity 30, with the valve 26 located in the straight segment 41 according to the illustrated embodiment, but possibly located at other locations in the closed circuit of the anti-icing system 20. The conduit 24 has its outlet end 42 in fluid communication with the anti-icing cavity 30. In the illustrated embodiment, the anti-icing system 20 may operate without any valve for the coolant phase C, with the straight segment 41 diametrically sized to define the path of least resistance for vapour to flow. Therefore, when the valve 26 is opened, the segment 41 of the feed conduit 24, located at the top of the engine 10, allows the vapour to flood the anti-icing cavity 30 before vapour is supplied to the surface cooler of the cooling phase C. The flow path of the feed conduit 24 toward the anti-icing cavity 30 is sized larger than the flow path toward the cooling phase C such that, if the valve 26, is opened the majority of the flow is to the anti-icing cavity 30. Alternatively, valves could also be present to selectively block the supply of vapour to the cooling phase C. Also, the anti-icing system 20 may not be fluidly connected to any cooling phase C.

The return conduit 25, distinct and separated from the feed conduit 24, has an inlet end 50 located in a lower portion of the anti-icing cavity 30. The outlet end 42 and the inlet end 50 are therefore distinct from one another and separated physically in the anti-icing cavity 30. Accordingly, condensate of change-phase fluid may be collected via the inlet end 50. In the illustrated embodiment of FIG. 5, the return conduit 25 has a generally straight segment 51 extending from the inlet end 50 to the reservoir 21, with or without the presence of the pump 27. The inlet end 50 and the return conduit 25 may be oriented and positioned in such a way that the condensate flows to the reservoir 21, without motive force, for instance by the attitude of the aircraft, etc. It is also considered to intermittently operate the pump 27 as a function of attitude of the aircraft supporting the engine 10. Moreover, a vapour pressure in the anti-icing cavity 30 may assist in directing condensate to the reservoir 21.

The anti-icing system 20 is of relatively low pressure and low temperature along with the possibility of employing a non flammable cooling fluid. As observed from FIGS. 3 and 4, the reservoir 21 is centrally located, such that the oil and change-phase fluid routings are centrally located so as to be shorter. The centralizing may also result in a single area needing greater protection or shielding.

The anti-icing cavity 30 of the anti-icing system 20 may be sized as needed for cooling. The majority of the heat to be rejected may come from sources near the central location of the reservoir 21, which may results in short tube/hose runs and minimizes the hidden oil in the system.

The resulting anti-icing system 20 and related method of anti-icing the inlet surface 19 relies on vapour generation to supply a high-energy vapour stream to the anti-icing cavity 30 where the vapour condenses and transfers energy to the leading surface 19 of the inlet. The vapour is at a relatively low but consistent temperature in comparison to engine bleed air, due to its boiling point. Because of the simplicity of the anti-icing system 20, inspection or service port requirements may be reduced, such that the drag and esthetics of the nacelle are not substantially affected by the anti-icing system 20. Since engine bleed air is not used, the specific fuel consumption of the gas turbine engine 10 during icing conditions may be improved in contrast to gas turbine engines 10 using engine bleed air. The heat used for vapour generator is heat that must be removed from the engine 10 so the anti-icing systems 20 may operate with no efficiency impact on the engine 10. The anti-icing system 20 could remain on at all times, to eliminate the valve 26.

The anti-icing system 20 could generate simply shortly after start of the engine 10, due to the inherent heat generation of a gas turbine engine 10, and the necessity to cool it. For example, the buffer air cooler can provide the heat required for anti-icing at any engine power shortly after start. Because the anti-icing system 20 operates at low pressure and well controlled temperature, e.g., 100 C, in contrast to bleed air arrangements, the feed conduits 24 can use non-insulated thin aluminum piping instead of thicker insulated steel ducting and hoses, piston-ring transfer tubes sensitive to vibrations. Also, the required diameters for the segments of the feed conduit(s) 24 and return conduits 25 may be kept relatively smaller than for bleed air since the required vapour volumetric flow rate for anti-icing capacity is one order of magnitude smaller than for air. The feed conduit(s) 24 may be a cost-effective and lightweight solution in contrast to air ducts. According to an embodiment, the return conduit 25 is inside and surrounded by the feed conduit 24, for example in concentric manner, as a safety measure to reduce the risk of freezing of the condensate.

No special control system is required since the temperature of the leading surface 19 will remain at a relatively low condensation temperature in any conditions (e.g., 100 C in the case of steam). The vapour will condense at a rate dictated by external flow heat load. In case of fire, the fact that the change-phase fluid may be non-flammable is advantageous. Inadvertent cases of vapour release in the nacelle may be harmless due to lower temperature (e.g., 100 C). By cooling the various heat exchangers 22 to the fluid boiling temperature, the change-phase fluid boils, the vapour is ducted into the anti-icing cavity 30 and condenses on the wall of the anti-icing surfaces 19 tending to bring the anti-icing surface 19 to the condensation temperature.

When a pump 27 is present, a relatively small water pump may be used to modulate the water flow. Two pumps 27 in parallel network of the return conduit(s) 25 may provide the required redundancy, although the anti-icing system 20 may be designed to work as a thermo-siphon as described above. The monitoring of the anti-icing system 20 could employ temperature sensors of all sorts, for instance measuring inner cowl temperature. In terms of freeze protection for the anti-icing system, for instance during an off state, the reservoir 21 may be a bladder-type reservoir. Also, the change-phase fluid may be an alcohol-water mixture. Electrical heating may also be used to initiate the first quantity of vapor, with the system 20 subsequently being self-sustained. The electrical heating may be provided directly by induction heating in the pump motors until the ice in the motor pumps melts, with no additional device required.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. An anti-icing system for a gas turbine engine comprising:
a closed circuit containing a change-phase fluid, at least one heating component for boiling the change-phase fluid, the anti-icing system configured so that the change-phase fluid partially vaporizes to a vapour state when boiled by the at least one heating component,
the closed circuit having an anti-icing cavity adapted to be in heat exchange with an anti-icing surface of the gas turbine engine for the change-phase fluid to release heat to the anti-icing surface and condense,
at least one feed conduit having an outlet end in fluid communication with the anti-icing cavity to feed the change-phase fluid in vapour state from heating by the at least one heating component to the anti-icing cavity, and at least one return conduit having an outlet end in fluid communication with the anti-icing cavity to direct condensed change-phase fluid from the anti-icing cavity to the at least one heating component.

2. The anti-icing system as defined in claim 1, further comprising a pressure regulator device in the closed circuit for regulating a boiling temperature of the change-phase fluid for same to vaporize when absorbing heat from the at least one heating component.

3. The anti-icing system according to claim 1, wherein the at least one heating component includes at least one heat exchanger configured to receive a first coolant from a first engine system for the change-phase fluid in the closed circuit to absorb heat from the first coolant.

4. The anti-icing system as defined in claim 3, wherein the first coolant circulating in the at least one heat exchanger is cooling oil.

5. The anti-icing system as defined in claim 1, wherein the anti-icing system operates by thermosiphon effect.

6. The anti-icing system as defined in claim 1, further comprising at least one pump in the at least one return conduit.

7. The anti-icing system as defined in claim 1, wherein the closed circuit has a reservoir for the change-phase fluid, the reservoir being below the inlet end of the anti-icing cavity for the condensed change-phase fluid to be directed to the reservoir by gravity.

8. The anti-icing system as defined in claim 7, wherein the at least one heating component includes a plurality of the heat exchangers, the plurality of heat exchangers being in the reservoir.

9. The anti-icing system as defined in claim 1, further comprising a valve in the feed conduit operable to direct the change-phase fluid in the vapour state to the anti-icing cavity.

10. The anti-icing system as defined in claim 1, wherein the closed circuit includes a cooling stage for cooling the change-phase fluid in the vapour state, the at least one feed conduit and the at least one return conduit connected to the cooling stage such that the cooling stage is in parallel to the anti-icing cavity.

11. The anti-icing system as defined in claim 10, further comprising a valve in the feed conduit operable to direct the change-phase fluid in the vapour state to the anti-icing cavity, a diametrical dimension of the at least one feed conduit being greater between the valve and the outlet end than a diametrical dimension of the at least one feed conduit in the cooling stage.

12. The anti-icing system as defined in claim 1, wherein the at least one return conduit is inside and surrounded by the at least one feed conduit.

13. The anti-icing system as defined in claim 3, comprising a plurality of the at least one heat exchanger configured to each be connected to an anti-icing system of one of engine systems including an auxiliary gearbox, a buffer air cooler, an air cooled oil cooler, and an integrated drive generator.

14. The anti-icing system as defined in claim 1, wherein the anti-icing cavity includes a wall defining the anti-icing surface of the gas turbine engine.

15. A method for heating an anti-icing surface of an aircraft comprising:
heating a change-phase fluid in a closed circuit to boil the change-phase fluid into a vapour state,
directing the change-phase fluid in the vapour state to an anti-icing cavity located in heat exchange relation with the anti-icing surface of the gas turbine to condense the change-phase fluid in the vapour state by heating the anti-icing surface, and
collecting the condensed change-phase fluid in a lower portion of the anti-icing cavity and directing the condensed change-phase fluid in the closed circuit to the at least one heating component to boil the change-phase fluid.

16. The method according to claim 15, wherein exposing the change-phase fluid comprises exposing the change-phase fluid to a coolant of at least one heat exchanger.

17. The method as claimed in claim 16, further comprising regulating a pressure of the change-phase fluid to expose the change-phase fluid to heat exchange with the coolant at a regulated pressure.

18. The method as claimed in claim 15, wherein the method is performed without motive force.

19. The method as claimed in claim 15, further comprising cooling a portion of the vaporized change-phase fluid to a cooling stage by directing the change-phase fluid in the vapour state to a cooling stage in parallel to the anti-icing cavity.

20. The method as claimed in claim 15, wherein directing the condensed change-phase fluid in the closed circuit to the at least one heating component comprises pumping the condensed change-phase fluid.
